(19) United States
(12) Patent Application Publication
(10) Pub. No.: US 2003/0014676 A1
(43) Pub. Date: Jan. 16, 2003

(54) Method of remote start of wireless transmission USB

(76) Inventors: Tzong-Yu Wang, Shulin City (TW); Shih-Jen Kuo, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/903,553

(22) Filed: Jul. 13, 2001

(51) Int. Cl. G06F 1/26

(52) U.S. Cl. 713/323

(57) ABSTRACT

A method of remote start of wireless transmission USB for application on computer systems of wireless perimeters as a sensor, formed by R/C charging/discharging devices or WATCH DOG TIME OUT, that regularly supplies power to wake up the sensor receiver through a remote start and, with signals available, the wake-up function could be carried out directly and in case no, the unit would switch to power-conservation suspend mode, so that the USB suspend power could be conserved.

### BACKGROUND OF THE INVENTION

The invention relates to a method of remote start of wireless transmission USB, for application between a computer and USB wireless perimeters, systems of unlimited perimeters, for determination whether to carry out wake-up functions with sensor that detects receiving signals, with the purpose of conservation of power consumption of USB when suspend, making the invention industrially applicable.

Between a conventional computer and its perimeters, an appropriate transmission medium shall be available for the connection of the signal wires, which are used for the switch between operation and data transmission; recently, there are wireless signal emitters and receivers to receive control signals emitted by various wireless perimeters, such as USB signal emitter, so that the USB perimeters could control computer operations through wireless means.

For the wireless perimeter, the computer USB signal emitter module and signal receiver module, when the system remains suspend, the USB keeps on consuming power as a waste. Besides, as the perimeter of the wake-up function of wireless perimeter remote control takes a fixed period of time to repeatedly send out identification codes, it could make the emitter module work repeatedly as a waste of energy. When the system remains suspend, this phenomenon could jeopardize the normal function of the remote wake-up.

The objective of the present invention aims is to provide a method of remote start of wireless transmission USB by means of establishing a sensor between the USB wireless perimeter and the computer host, so that the sensor could regularly supply power to the remote start for the detection of signals in the receiver and determine whether to carry out the wake-up function, as a way to converse power consumption with the USB suspend.

According to this invention, the method of remote start of the wireless USB is to establish a sensor that regularly wakes up either by means of R/C charging or discharging, or by WATCH DOG TIME OUT, so that it could detect whether the receiver is working, if signals are available, it then remain suspend to conserve power consumption of USB when suspend.

### BRIEF DESCRIPTION OF THE DRAWING

FIG. 1 shows the system diagram of this invention.

### DESCRIPTION OF THE INVENTION

A method of remote start of wireless transmission USB of this invention is used between wireless perimeter computer 20, in particular, a computer system using USB keyboard and mouse.

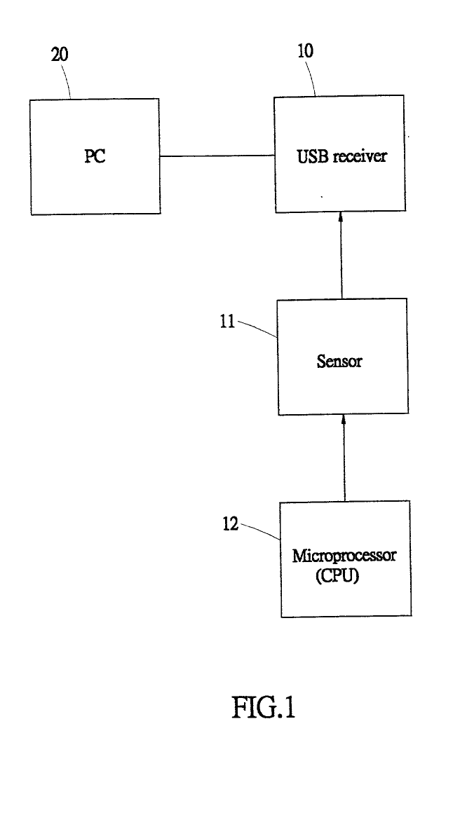

In the system framework of the invention, as shown in FIG. 1, the remote start of wireless transmission USB deals with a sensor 11 that is to detect signals from the USB receiver 10; the sensor 11 is controlled by microprocessor 12 that regularly wakes up to detect the USB receiver 10, when there are signals, it carries out REMOTE WAKEUP, if not, the system would then remain SUSPEND to conserve energy.

The sensor 11, RC charging/discharging circuits may be used to provide power regularly, so that the remote start could detect start signals. If yes, it could then proceed with the wake-up function and have the system work. If not, the system would remain suspend to conserve energy.

The sensor 11 could also regularly provides power by means of WATCH DOG TIME OUT, so that the remote start could detect for start signals. If yes, it could wake the system up to work. If not, the system could remain suspend to conserve energy.

The sensor 11 may also be a software or hardware device featuring the aforementioned characteristics that, through this sensor 11. When the remote start detects signals in the wireless perimeter, it could suggest that the RF module in the USB wireless perimeter is on to enter into the wake-up function. If the RF module does not work, the system would then remain suspend to conserve energy and this could reduce the time for USB's identification of signals, while improving the overall efficiency.

This method makes the USB wireless perimeter, when not on, keep the system suspend to conserve energy, so that both the receiver and the emitter could improve the transmission quality.

Therefore, the method of remote start of wireless transmission USB of this invention is to regularly provide power to the receiver for the detection of signals through a simple signal sensor, so that it could keep the remote start and USB in normal operations. The method not only conserves energy, but also reduces signal identification time, so that USB signal transmission could be conducted more steadily as related above.

What is claimed is:

1. A method of remote start of wireless transmission USB applying on computer systems of wireless perimeters as a sensor that regularly detects USB receiver signals and the sensor is controlled by microprocessors that regularly wake up to detect the USB receiver, when there are signals, the system would proceed with REMOTE WAKE UP; when there is no signal, the system would remain SUSPEND to conserve energy.

2. A method of remote start of wireless transmission USB as claimed in claim 1, wherein sensor regularly provides power using RC charging and discharging circuits, so that the remote start detects for start signals.

3. A method of remote start of wireless transmission USB as claimed in claim 1, wherein the sensor regularly provides power through WATCHDOG TIMEOUT, so that the remote start could detect for start signals.

4. A method of remote start of wireless transmission USB as claimed in claim 1, wherein the hardware and software regularly provides power to the remote start for its detection of start signals.
